(19) United States
(12) Patent Application Publication
(10) Pub. No.: US 2010/0296716 A1
(43) Pub. Date: Nov. 25, 2010

(54) TOMOGRAMS FOR IMPLANT PLANNING

(75) Inventors: Niels Hanssen, Bonn (DE); Frank Buellesfeld, Bonn (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: SICAT GMBH & CO. KG, Bonn (DE)

(21) Appl. No.: 12/740,360

(22) PCT Filed: Sep. 18, 2008
(86) PCT No.: PCT/EP2008/062488

§ 371 Date: Aug. 10, 2010

(30) Foreign Application Priority Data
Oct. 30, 2007 (DE) 10 2007 051 719.1

(51) Int. Cl. G06K 9/00

(52) U.S. Cl. 382/131

(57) ABSTRACT

Method for creating and presenting layer images that are generated from a set of volume data, whereby the volume data are recorded with a tomographic recording device, for example with a “cone beam CT” device, and show the jaw area of a patient, whereby planning data are assigned to the volume data, and said planning data describe the position of an implant that is to be inserted into the jaw and that has an implant axis, whereby a coordinate system that is adapted to a panoramic curve or a panoramic surface is defined that is formed by the vectors u, v, and w that are orthogonal to one another, whereby for the creation and presentation of a layer image, a representational plane is selected that intersects an implant that is described by the planning data, whereby in a first case, the v vector is orthogonal to the panoramic surface and/or the panoramic curve, and the implant axis intersects in a reference point, whereby the reference point is selected as the origin of the coordinate system, whereby the w-vector that runs through the reference point is tilted in such a way that the implant axis lies in the v, w-plane, whereby the v, w-plane forms a first base plane and whereby a representational plane that is parallel to the first base plane is selected, whereby in a second case, the u vector intersects the implant axis in a reference point and is parallel to the tangent on the panoramic curve in the perpendicular point of the reference point to the panoramic curve, whereby the w-vector of the coordinate system is tilted in such a way that the implant axis lies in the u, w-plane, whereby the u, w-plane forms a second base plane and whereby a representational plane that is parallel to the second base plane is selected.

This invention relates to a method for creating and presenting layer images that are generated from a set of volume data, whereby the volume data are recorded with a tomographic recording device, for example with a “cone beam CT” device, and show the jaw area of a patient, whereby planning data are assigned to the volume data, and said planning data describe the position of an implant that is to be inserted into the jaw and that has an implant axis, whereby a coordinate system that is adapted to a panoramic curve is defined that is formed by the vectors u, v, and w that are orthogonal to one another, whereby for the creation and presentation of a layer image, a representational plane is selected that intersects an implant that is described by the planning data.

To ensure sufficient hold while inserting tooth implants, and to protect the surrounding anatomy as well as possible, the position of the future implants in the jaw bone is of decisive importance. In order to determine these exactly, virtual plans in the volume data, from which the planning data are produced, are performed in the preliminary area. After the planning of the implants is concluded, the latter has to be implemented in practice.

To make practical implementation possible for the operating physician, drilling templates can be created, for example, based on the planning data and can then during treatment be placed on the corresponding jaw area and limit the physician's degrees of freedom during the drilling to be done. The production of such drilling templates is comparatively expensive, such that the physician frequently decides to perform the drilling “free-hand” based on his existing cross-sectional images generated from the planning. In this case, he is first oriented especially readily to a panoramic projection, which provides him with the necessary overview.

In the case of the free-hand operation, the physician, however, has to have available as exact as possible a display of the anatomy and the implant inserted therein. For this purpose, on the one hand, displays are known that present cross-sections to the physician that are oriented to an overall orthogonal (x, y, z)-coordinate system. An individual layer along one of the main axes contains too little information, however, to be able to evaluate the position of the implant well. Specifically, a volumetric 3-D view of the anatomy with the implants offers a relatively good estimate of the orientation of the implants relative to one another; the position of the implants in relation to the bone and the nerve canal is only roughly visible to the physician.

To improve the display, a coordinate system was introduced that matches the curved anatomy of the jaw. This anatomy-adapted coordinate system (p, q, r) with its p-coordinate follows the curved course of the jaw along a previously defined panoramic curve. While the r-coordinate corresponds to the vertical z-coordinate of the (x, y, z)-coordinate system, the q-coordinate is perpendicular to p and r. From transverse cross-sectional views (TSA) that run perpendicular to the panoramic curve, the incline of an implant in the buccal-oral direction can now be evaluated. And from lateral cross-sectional views (LSA) that run tangentially to the panoramic curve, the incline of an implant in the mesial-distal direction can be evaluated.

The evaluation of the position of planned implants, which are tilted in both the mesial-distal and buccal-oral directions, is problematic in the known procedure, however. In these cases, which are among the most common, only an oblique section of the implant is visible in the transverse (lateral) layer in each case. Another drawback is that through the oblique section, none of the possible positions of the transverse (lateral) layers according to the p-coordinates (q-coordinates) has a prominent setting. This fact is often counteracted in that a series of transverse (lateral) sections according to the p-coordinate (q-coordinate) are presented to the physician for an implant.

The object of the invention is now to provide a generic process that can be implemented simply and that ensures for the attending physician a conclusive display of a planned implant or its operative canal relative to the surrounding anatomy of the jaw.

This object is achieved by the process according to claim 1. Especially advantageous embodiments are mentioned in the subclaims.

The basic idea of the invention is to transform the coordinate system in such a way that conclusive layer images through the jaw can be presented to the physician that are oriented, on the one hand, to the panoramic curve or optionally to a panoramic surface and that, on the other hand, in each case are parallel to the implant axis, which forms an axis of symmetry. For implementing the process, a tilting of the otherwise vertically oriented transverse or lateral layer adapted to the position of the planned implant is performed, such that the implant axis comes to lie in these two layers. In this case, an essential point of the underlying design of this invention is that the two layers are tilted independently of one another. In this way, the entire cross-section of the implant is visible to the physician from both of the views that are available to him. In this case, the invention is also based essentially on the fact that the implant, as an implant axis, has an axis of symmetry as is the case in particular in cylindrical implants.

The essential point of the invention is the introduction of a coordinate system, which is based on the u-, v- and w-axes. While the (x, y, z)-system is a global, Cartesian, non-jaw-adapted coordinate system, its origin is somewhere in space, e.g., in the center of the head, whereby the z-axis corresponds to the vertical body axis and the (x, y)-plane intersects the body horizontally, and the (u, v, w)-system is a local, jaw-adapted coordinate system. In this case, “local” means that the (u, v, w)-system is always defined relative to a reference point. While only a single global (x, y, z)-system and a single global (p, q, r)-system exist, there are an infinite number of (u, v, w)-systems, namely for any reference point. The origin of this (u, v, w)-coordinate system is at the reference point and thus somewhere in space, in particular somewhere on the implant axis. The u-axis should then correspond to the tangent in the perpendicular point of the reference point on the panoramic curve through the reference point and the v-axis of the orthogonal to the panoramic curve through the reference point. The w-axis corresponds to the z-axis.

Moreover, for terminology, it should be noted that a transverse layer orthogonally intersects the panoramic curve, while a lateral layer runs tangentially to the panoramic curve.

According to the invention, the transverse layer is tilted around the v-axis or the lateral layer is tilted around the u-axis, so that the buccal-oral tilting or the mesial-distal tilting that is perpendicular thereto can be detected as an angle between the implant axis and the perpendicular within the layer, when the display of the layers—as is advantageous—is shown in a coordinate system with a horizontal base plane and a vertical body axis, whereby the coordinate system corresponds to the patient. Quite generally, the procedure according to the invention does not only assist in the implementation of the planning, but also even in the planning of the implants, since such a display is especially well regarded as the implant is arranged relative to the surrounding anatomy. Thus, possible planning errors, such as the penetration of the implant in critical areas, can be significantly better avoided than previously.

According to the invention, the adaptation is performed automatically by a computer, which in the implementation performs the following steps, whereby it is to be distinguished whether a transverse and/or a lateral layer is to be shown: in the first case, the v-axis that is orthogonal to the panoramic curve or the panoramic surface is first designed, which intersects the implant axis, whereby the point of intersection forms a reference point. In most cases in which the panoramic surface is formed by the panoramic curve that rises in the vertical, it comes out to the same thing regardless of whether the panoramic curve or the panoramic surface forms the basis for the design of the v-axis. It makes a difference in the case of panoramic surfaces that have distortions in the vertical. The reference point designed on the implant axis is selected as the origin of the coordinate system. Now, a w-axis that runs through the reference point is defined in such a way that the implant axis lies in the v, w-plane. The v, w-plane, which forms a first base plane, is thus rotated to a certain extent around the v-axis. As a representational plane, this first base plane or a plane parallel thereto is now shown on the monitor to the physician. In addition to or within the scope of the “reporting,” the output is produced by, for example, a printer.

Based on these transverse sections tilted corresponding to the implant axis, the physician can now optimally detect the position of the implant in the jaw. In this case, it is advantageous if the sections are shown in reference to the body-relative horizontal line, so that the tilting angle of the implant is visible to the physician. If several transverse representational planes are determined, the latter can be shown, e.g., in a common overall view. For the physician, however, primarily the central representational plane is especially interesting. In this “implant-directed TSA,” the buccal-oral tendency of the implant is easily detectable. Alternatively, there is also the interactive display on the monitor in which the representational plane can be moved interactively in parallel.

A second base plane can be designed by a u-axis being studied that intersects the implant axis in a reference point and that is parallel to the tangent on the panoramic curve, whereby the tangent runs in particular through the point of intersection of the perpendicular line of the reference point with the panoramic curve. Now, the w-axis of the coordinate system is defined in such a way that the implant axis lies in the u, w-plane. The u,w-plane, which forms a second base plane, is thus rotated around the u-axis. As a representational plane, this second base plane or a plane that is parallel thereto is now presented to the physician.

Based on a lateral section that is tilted in such a way, the physician can detect the position of the implant relative to the adjacent teeth especially easily. In this “implant-oriented LSA,” the mesial-distal inclination of the implant is readily detectable. As already indicated above, in turn, e.g., one or more TSA together with at least one LSA in a common image can be seen by the physician. Also, a top view can be shown in this common image. In this case, it is advantageous to show the views on the monitor and/or on the printer and to indicate therein the respective lines of intersection with the other representational planes. Analogously to the TSA, there is also in the LSA the interactive display on the monitor, in which the representational plane can be moved interactively in parallel.

It may be advantageous to give the physician the option to rotate the display around the implant axis. In the context of the interactive display, the rotation around the implant axis is an important aspect of the invention. Thus, the physician, e.g., within the scope of the final check, can rotate the representational plane once completely around the implant in order to ensure that the implant actually is seated well in the bone in all directions, i.e., not only in the two designated directions orthogonal and tangential to the panoramic curve.

According to the invention, a rotation can be performed around the implant axis, whereby the tilting angle always remains evident relative to the reference system. To this end, the u- and v-axes—before the tilting of the representational plane in the implant axis—are rotated at the desired angle of rotation around the w-axis. The advantage of the detection of the tilting angle in this case slightly outweighs the disadvantage of the slightly moving implant. If the implant is tilted, e.g., in the TSA, by 10° and in the LSA by 20′, then the implant tilts during the rotation from the TSA to the LSA slightly from 10° to 20°.

As an alternative to this, the representational plane at the end of the construction can be rotated in such a way that the implant is always oriented vertically. This procedure has the advantage that the implant during the rotation remains “settled” in the image and the physician can thus concentrate on the area around the implant during the rotation. It is disadvantageous, however, that the important information on the tilting relative to the reference system is lost.

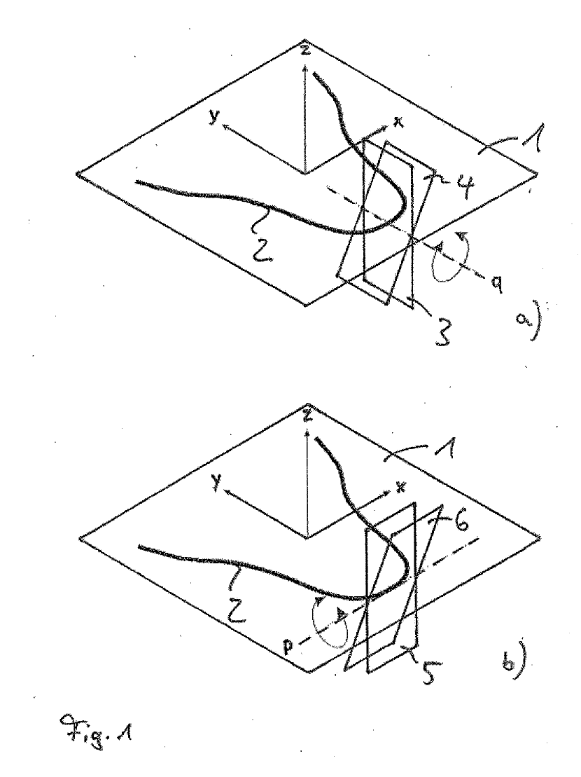

Below, the invention is explained in more detail based on the FIGS. 1 to 3. In this case:

FIG. 1 shows planes in jaw-adapted coordinate systems,

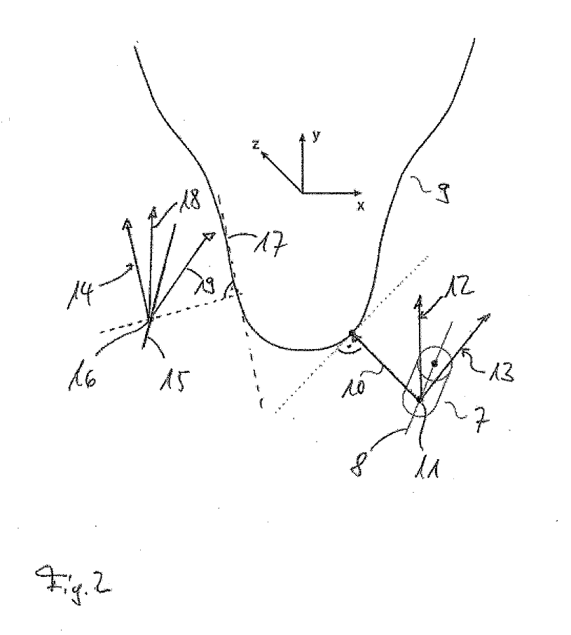

FIG. 2 shows the design of a tilted, transverse plane as well as a tilted lateral plane, and

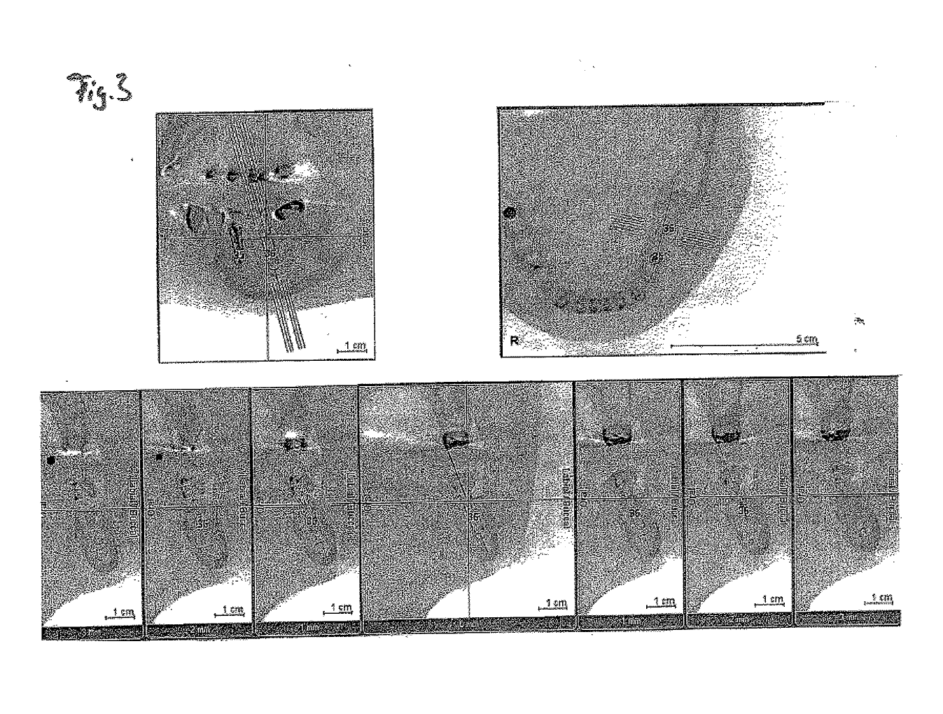

FIG. 3 shows a planning report.

FIG. 1 shows a plane 1 that is defined first in the overall 3D coordinate system of the origin that is formed by the vectors x, y and z. In the plane 1, a panoramic curve 2, which follows the course of the jaw, is fixed manually or automatically. Within the coordinate system of the origin, a jaw-adapted coordinate system that is formed via the v- and w-axes is defined according to the invention at a reference point that in this figure lies, by way of exception, on the panoramic curve 2, whereby the w-axis is first oriented vertically and corresponds to the original z-direction. The v-axis is orthogonal (transversal) to the panoramic curve 2, while u is tangential (lateral) thereto.

FIG. 1a shows a conventional transverse layer 3 and a transverse layer 4 that is tilted against it and rotated around the v-axis. FIG. 1b correspondingly shows a conventional lateral layer 5 and a lateral layer 6 that is tilted against it and rotated around the u-axis.

The axes are also shown in FIG. 2, in which the cylindrical implant 7 with its axis of symmetry 8 can also be seen. Starting from the panoramic curve 9, a v-axis 10 that is orthogonal to the panoramic curve, which intersects the implant axis 8 at a reference point 11, is sought. The reference point 11 is selected as the origin of the new coordinate system. Now, a w′-axis that runs through the reference point is defined such that the implant axis 8 lies in the v, w′-plane. This takes place by the vertical w-axis first being tilted around the v-axis by an angle α and becoming the w′-axis.

In the case of the design of the tilted lateral plane, the u-axis 14 intersects the implant axis 15 at a reference point 16 and parallel to the tangent 17 on the panoramic curve 9 in the perpendicular point of the reference point with the panoramic curve. Now, the w-axis 18 of the coordinate system is tilted (w′-axis 19) in such a way that the implant axis 15 lies in the u, w′-plane. This takes place by the vertical w-vector first being tilted around the u-vector by an angle β and becoming the vector w′.

FIG. 3, which shows a “planning report” of the cylindrical implant No. 36, represents, in the bottom middle in the display, the tilted transverse section through the implant axis, which forms the base plane. In this case, the display is carried out in the coordinate system that is oriented to the patient and that has a vertical line. Sections that are parallel to the base plane are shown in the displays on the left and right of the display of the base plane.

On the top left, the tilted lateral section is shown by the implant axis. On the top right, a top view is shown, in which the implant No. 36 as well as the lateral layer and the transverse layer 20 are indicated.

The tilting of the implant in the buccal-oral direction (and thus the tilting of the LSA) is evident in the central TSA. The tilting of the implant in the mesial-distal direction (and thus the tilting of the TSAs) is detectable in the LSA.

Below, the steps of the construction can be shown once more:
1. In the first step, a reference point is selected on the implant axis.
2. In the second step, the perpendicular line is dropped from the reference point onto the panoramic curve.
3. In the third step, the u-, v- and w-axes are fixed as follows:
   The u-axis is parallel to the tangent on the panoramic curve through the perpendicular point
   The v-axis is the orthogonal line to the panoramic curve through the reference point (and thus through the perpendicular point)
   The w-axis corresponds to the z-axis
4. In the fourth step, optionally the u-axis and the v-axis are rotated around the w-axis.
5. In the fifth step, the following are tilted:
   TSA: The (v, w)-plane is tilted around the v-axis until the implant axis lies in the (v, w)-plane
   LSA: The (u, w)-plane is tilted around the u-axis until the implant axis lies in the (u, w)-plane
6. In the sixth step, optionally the representational plane is “sell”-rotated.
   TSA: The (v, w)-plane is rotated around the u-axis until the w-axis corresponds to the implant axis
   LSA: The (u, w)-plane is rotated around the v-axis until the w-axis corresponds to the implant axis.

1. Method for creating and presenting layer images that are generated from a set of volume data, whereby the volume data are recorded with a tomographic recording device, for example with a “cone beam CT” device, and show the jaw area of a patient, whereby planning data are assigned to the volume data, and said planning data describe the position of an implant that is to be inserted into the jaw and that has an implant axis, whereby a coordinate system that is adapted to a panoramic curve or a panoramic surface is defined that is formed by the vectors u, v, and w that are orthogonal to one another, whereby for the creation and presentation of a layer image, a representational plane is selected that intersects an implant that is described by the planning data,
characterized in that
in a first case, the v vector is orthogonal to the panoramic surface and/or the panoramic curve, and the implant axis intersects in a reference point, whereby the reference point is selected as the origin of the coordinate system, whereby the w-vector that runs through the reference point is tilted in such a way that the implant axis lies in the v, w-plane, whereby the v, w-plane forms a first base plane and whereby a representational plane that is parallel to the first base plane is selected,
in that in a second case, the u vector intersects the implant axis in a reference point and is parallel to the tangent on the panoramic curve in the perpendicular point of the reference point to the panoramic curve, whereby the w-vector of the coordinate system is tilted in such a way that the implant axis lies in the u, w-plane, whereby the u, w-plane forms a second base plane and whereby a representational plane that is parallel to the second base plane is selected.

2. Method according to claim 1,
wherein
the coordinate system is rotated around the u-axis in such a way that the w-axis corresponds to the implant axis.

3. Method according to claim 1,
wherein
the coordinate system is rotated around the v-axis in such a way that the w-axis corresponds to the implant axis.

4. Method according to claim 1,
wherein
the base plane is selected as a representational plane.

5. Method according to claim 1,
wherein
in the presentation on a 2D-output medium, the w-axis is plotted vertically and the u- and v-axis are plotted horizontally.

6. Method according to claim 1,
wherein
several representational planes that are parallel to one of the two base planes are determined and represented.

7. Method according to claim 1,
wherein
a rotation is performed around the implant axis by the u- and v-axes being rotated around the w-axis at the desired angle of rotation before the tilting of the representational plane in the implant axis.
